(19) United States
(12) Patent Application Publication
(10) Pub. No.: US 2008/0215387 A1
(43) Pub. Date: Sep. 4, 2008

(54) Automation of Validation Life Cycle and Providing 100% Paperless Electronic Validation Process

(76) Inventor: Sivakumar Muthusamy, Livermore, CA (US)

Correspondence Address: WHITE-WELKER & WELKER, LLC, P.O. BOX 199, CLEAR SPRING, MD, 21722-0199, US

(21) Appl. No.: 11/466,100

(22) Filed: Aug. 21, 2006

Related U.S. Application Data
(60) Provisional application No. 60/710,140, filed on Aug. 22, 2005.

(51) Int. Cl. G06Q 10/00

(52) U.S. Cl. 705/7

(57) ABSTRACT

The present invention relates to a software process that provides: an increase in the productivity in the validation process; tracking of the validation inventory, paperless execution of validation protocols; automation of revalidation schedule with alert features; increased validation efficiency; and ensures compliance to FDA regulations.

### CROSS REFERENCE TO RELATED APPLICATIONS:

This application claims priority from U.S. Provisional Patent Application Ser. No. 60/710,140, entitled “Automation of Validation Life Cycle and Providing 100% Paperless Electronic Validation Process”, filed on Aug. 22, 2005.

### SEQUENCE LISTING OR PROGRAM: Not Applicable

### FEDERALLY SPONSORED RESEARCH

Not Applicable

### TECHNICAL FIELD OF THE INVENTION

This invention relates to a paperless electronic validation process. More specifically, the present invention relates to software means that provides: an increase in the productivity in the validation process; tracking of the validation inventory, paperless execution of validation protocols; automation of revalidation schedule with alert features; increased validation efficiency; and ensures compliance to FDA regulations.

### BACKGROUND OF THE INVENTION

Up until now, firms operating in FDA regulated industries were confronted with choosing between maintaining more efficient validation processes that loosely complied with federal regulations, or sustaining less efficient validation processes that agreed fully with FDA compliance demands. Current and prior management of validation processes consisted of manually maintaining and processing paper. Striking a balance between efficiency and compliance has been critical in determining success in highly competitive FDA regulated markets. Factors such as cost and risk were calculated into finding the ideal balance between these two competing goals. With the automation of validation process, Companies operating in the FDA space can achieve efficiency while meeting FDA compliance requirements fully. By automating corporate validation process, companies can experience streamlined, efficient validation processes that enforce compliance throughout the validation lifecycle.

Prior to the emergence of computer technologies and electronic based systems, the entire validation process was conducted through paper-based means. Although useful at one time, paper-based systems are inherently flawed causing significant inefficiencies, increased costs, and non-compliant operating procedures.

Some of these shortcomings include the inability to track validation documents in a timely manner. There are also no controls to ensure that validation processes are completed on time.

Data integrity associated with the current systems for validation documents can be easily manipulated. Being unable to maintain accurate and complete records of the users involved in developing, executing, and approving validation documents results in the lack of integrity but also a lack of accountability. Additionally, from user to user, the development and execution of validation documents differs as a result of using inconsistent template and procedure resulting in inconsistent validation documents.

Storage and Retrieval—Manually storing and retrieving validation documents is a time consuming process. Physical copies of validation documents can be lost while traversing the manual development, execution, and approval workflows.

Reliance upon outside consultants and the outsourcing of validation tasks to third parties only serves to drive up the cost of validating entities.

Yet another shortcoming with paper-based systems is with the generating of validation document numbers. Creating consistent, unique validation document numbers is prone to human error and time consuming. Additionally, spelling mistakes and illegible handwriting on executed validation documents results in illegible and data recording errors. Revalidating entities is complex and susceptible to human error as well resulting in critical GxP entities not being validated on time or at all.

Finally, tracking the validation status and organizing compulsory documents for internal or FDA audits is time consuming and error prone due to misplaced records and decentralized storage.

### SUMMARY OF THE INVENTION

Accordingly, the general purpose of the invention is to automate the validation process that should overcome the inherent shortcomings and flaws associated with paper-based validation processes and allow companies to benefit from the advantages of electronic-based systems.

A plurality of befits can be achieved by the automation of validation process of the present invention. It is one objective of the present invention to provide a Track Validation Status for attaining the validation status of any entity registered in the system in real time.

It is another objective of the present invention to Ensured Data Integrity. The electronic system of the present invention controls access to documents assuring that documents cannot be manipulated. Accountability is ensured within the system by providing complete audit trails capturing User ID with Date and Time stamps for each activity that has occurred. Consistency is maintained via means that require validation documents developed within the electronic system to be created using approved templates ensuring document consistency throughout the organization.

It is yet another objective of the present invention to provide a Validation Document Number Generation means that automatically generates unique, consistent validation document numbers that can be configured.

System Controlled Documents are validation documents that are controlled and stored by the system in a secure central server for quick and easy retrieval eliminating the possibility of lost or misplaced documents, which is another objective of the present invention.

The present invention also teaches a Task Alert Feature that ensures that users are notified of any impending document development, execution, or approval tasks that Bridges the Communication Gap, a known shortcoming in the prior art.

Still another objective of the present invention is the teaching of Dynamic Audit Trails that are audit trails for document development, execution, and approval tasks which are dynamically created and can be retrieved in real time in the event of internal or FDA audits.

The final objective of the present invention is to teach a Revalidation Scheduler that allows the electronic system of the present invention to manage complex validation schedules alerting selected groups of any delayed or impending revalidation tasks ensuring that critical GxP entities are compliant.

### BRIEF DESCRIPTION OF THE DRAWINGS

FIG. 1 is a high level flow diagram illustrating components, and specifically how the word components are used and the general data flow;

FIG. 2 is a flow chart illustrating the category, subcategory and entity layers of the present invention;

FIG. 3 is a wire frame drawing of a the Inventory Manager Report screen of the present invention; and

FIG. 4 is a flow chart illustrating the data flow the enables forced consistency through template binding.

### DETAILED DESCRIPTION OF THE INVENTION

In the following detailed description of the invention of exemplary embodiments of the invention, reference is made to the accompanying drawings (where like numbers represent like elements), which form a part hereof, and in which are shown by way of illustration specific exemplary embodiments in which the invention may be practiced.

These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the apparatus of the present invention. The invention is a software process that provides: an increase in the productivity in the validation process; tracking of the validation inventory, paperless execution of validation protocols; automation of revalidation schedule with alert features; increased validation efficiency; and ensures compliance to FDA regulations.

The system of the present invention is based on an architecture that includes process, software, hardware and interfaces. The system is designed to capture and maintain validation data through a variety of manual and machine processes in real time with customized software and a database repository for storing information.

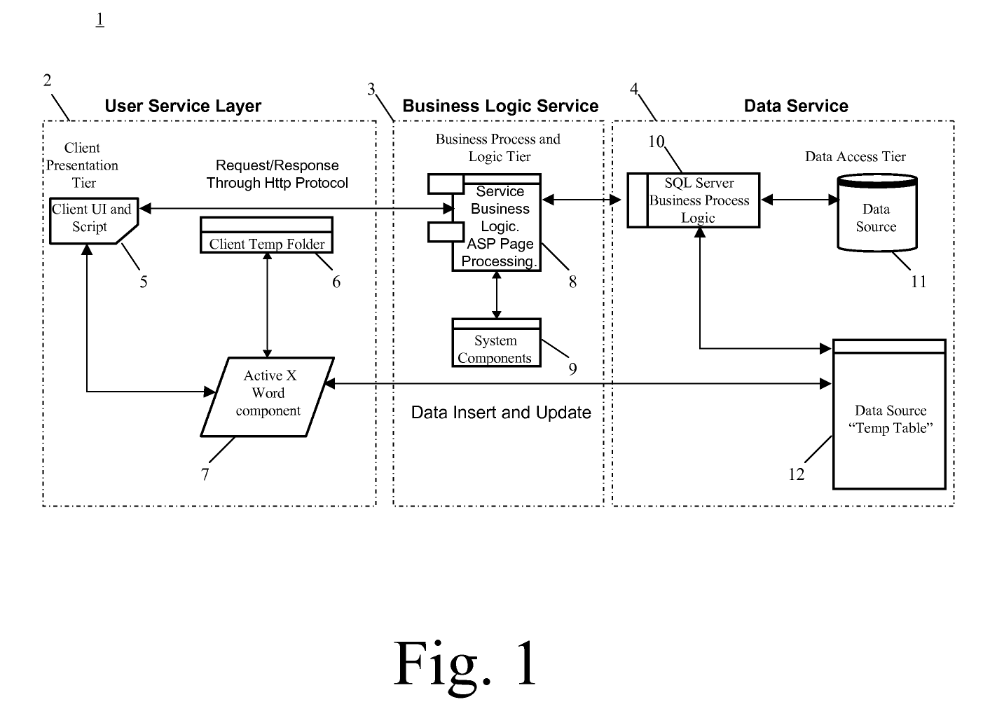

Now referring to FIG. 1, a high level flow diagram illustrating components, and specifically how the components are used and the general data flow is provided for reference. The system 1 is comprised of three major components: a user service layer 2, a business logic service layer 3, and a data service layer 4.

The user service layer 2 is further comprised of a client presentation tier consisting of the client user interface (UI) and scripts 5. The client user interface (UI) and scripts 5 enables a user to create or edit Word documents via the ActiveX Word component 7 within the user service layer 1 or access the Business Logic Service 3. The ActiveX Word component of the user service layer 1 can further access the client temp folder 6 to retrieve information as necessary or engage the data source “temp” table 12 as necessary to create, modify, and edit Word documents.

The Business Logic Service 3 consists of the service business logic and ASP page Processing components 8 and system components 9. The service business logic and ASP page Processing components 8 can interact directly with either the client UI 5 of the user service layer 1 or the SQL server business process logic 10 of the data service layer 4.

The data service layer 4 consists of the SQL server business process logic 10, a data source 11 and a data source “temp” table 12 used for Word document transactions. The SQL server business process logic 10 can obtain data from the data source 11 or interact with the data source “temp” table 12 as necessary via FTP components to transfer the documents from client to server and vice versa to create, modify, and edit Word documents.

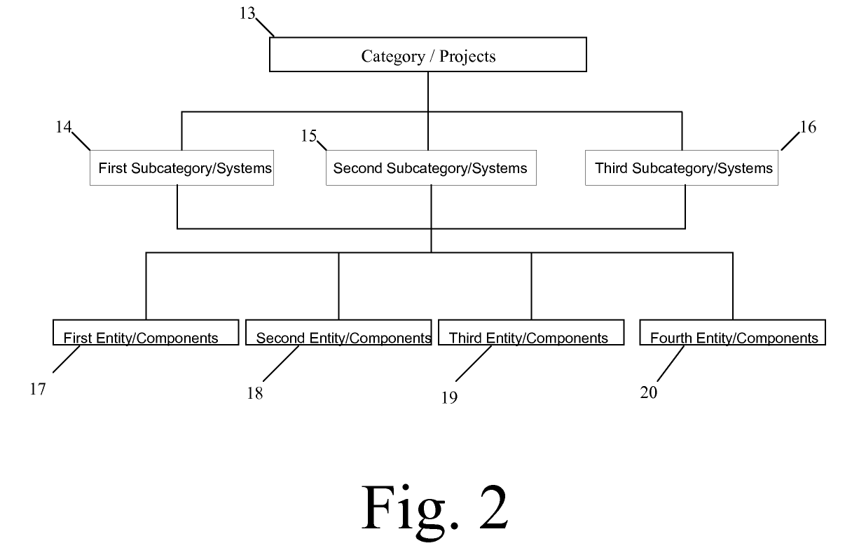

Entities requiring validation include any software, hardware, equipment, instrument, etc. that can be categorized 13 and further sub categorized into a first sub category 14, second sub category 15, third sub category 16, etc for easy navigation in the invention's tree hierarchy structure as illustrated by FIG. 2. Registered entities such as a first entity 17, second entity 18, third entity 19, fourth entity 20, etc. are available for viewing and selection under appropriate sub categories.

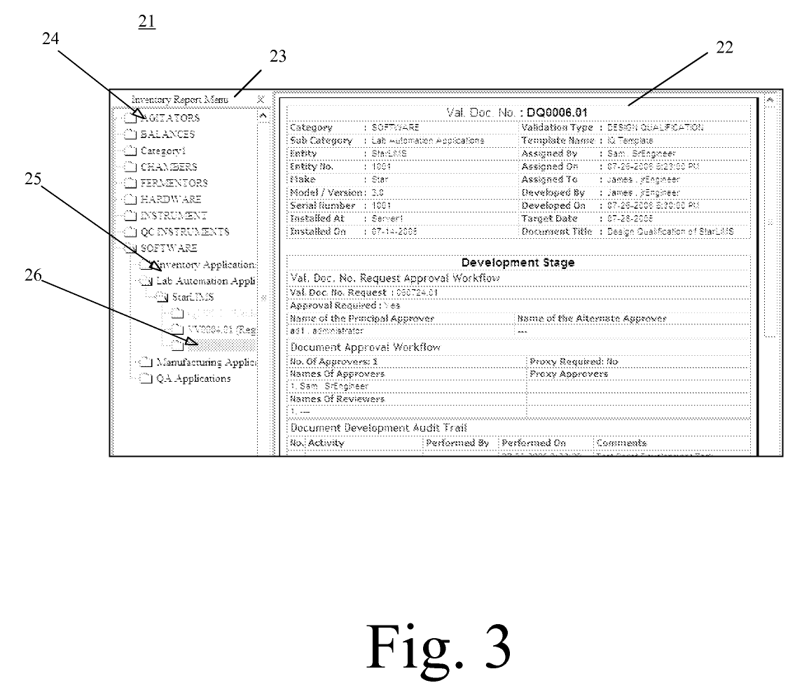

Now referring to FIG. 3, an Inventory Report Manager 21 will allow the user to track the validation status of any entity that is registered in the system. The Inventory Report Manager 21 stores entities in a user-friendly tree hierarchy menu 23 in a first screen portion for simplified navigation and selection and also displays validation document information in a second screen portion 22. The user-friendly tree hierarchy menu 23 located in a first screen portion for simplified navigation includes categories 24, sub categories 25, and entities 26.

The Inventory Report Manager 21 saves a significant amount of time that would be otherwise spent manually searching for specific entities 26 and tracking the validation status. Using the present invention, an entity 26 can be located with a minimal number of mouse clicks providing complete details outlining the validation status with User ID and Date and Time Stamps captured for each activity associated with an entity. The Inventory Report Manager 23 improves the efficiency of tracking entities and reviewing validation status by providing an automated method of searching, selecting and displaying information stored in the inventions database.

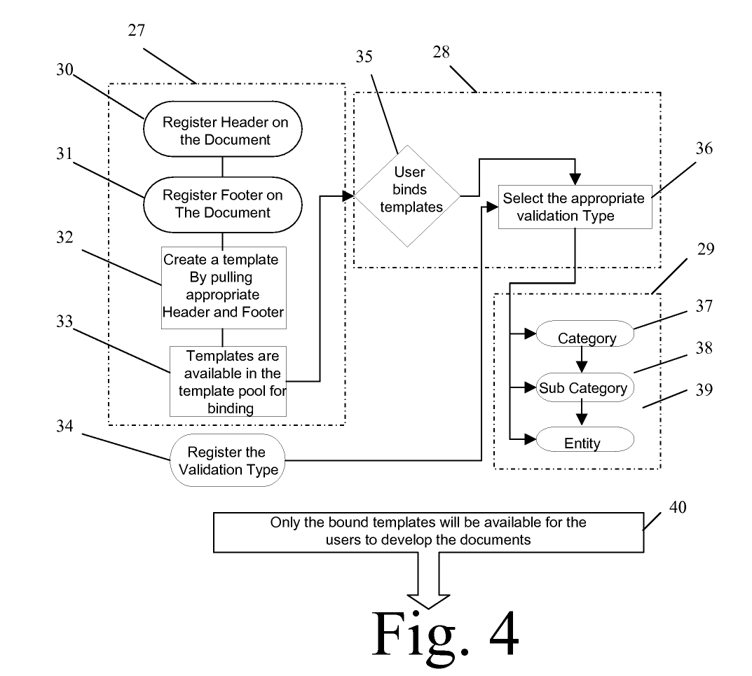

In the present invention, validation consistency is enforced through the use of validation document templates and binding as illustrated in FIG. 4. The user may create and register and store any number of custom validation templates using the invention. Once a custom template is registered and stored in the invention's database, the user responsible for creating a validation document for an entity must use the custom template, resulting in validation document consistency and enforces compliance in the validation process, which is not present or inadequate using current art.

When a user creates a custom validation document template during the template creation phase 27, the user may insert and register custom headers 30 and custom footers 31 to the validation document and will pull the Meta data populating the custom validation document template dynamically from the database 32. As with the custom validation document template creation, custom header and footer templates are configurable and easy to create. Once the custom validation document template is registered into the system it is available in the template pool for binding 33 and is then bound 35, or linked, to a selected specific validation type 36 during the template binding process 28. Creating a Custom Validation Document Template ensures consistency among all validation documents of the same validation type.

Now referring to the typing phase 27 of the template binding process illustrated by FIG. 4, if a user registers the template under a category 37, all the sub categories 38 and entities 39 underneath the category 37 will inherit the templates. If the user registers the template under a sub category 38, all the entities 39 under the sub category 38 will inherit the templates. If the user registers the template under the entity 39, the templates will be available only for this entity 39. Only bound templates are available for users to develop into the documents 40.

In the present invention, a revalidation scheduler alerts predefined user groups of any scheduled or delayed revalidation tasks ensuring that critical entities are revalidated on time and in compliance with governmental regulations. All the validated entities within the system may be selected or deselected by the user for inclusion in the revalidation schedule. Once a revalidation schedule has been created, the selected user groups will be alerted of impending and delayed revalidation tasks through the Task Alert Feature. By alerting groups of users, the invention reduces the likelihood of the user receiving FDA issued warning letters and citations resulting from failing to revalidate critical GxP entities.

In paper-based validation systems, the subject of the current art, manually managing revalidation schedules is a complex task that is prone to human error. Failing to revalidate critical GxP entities could result in FDA issued warning letters and citations.

The present invention generates a unique barcode for each entity registered in the system, helping the user track the validation status of entities in remote locations. A barcode is printable using any off-the-shelf printer and proper-sized labels and can be physically attached to the entity so it can be used to identify the validation details of an entity. The barcode label may be scanned and the validation information stored in the invention's database associated with the barcode will be presented to the user. The barcode code can be configured to capture the validation status, revalidation schedule, and changes occurred after the validation.

Through a handheld scanning device, the entity can be scanned on the production floor with requested validation status details being displayed. The barcode feature ensures that systems, instruments, and equipment and other such entities, can easily be determined to be properly validated, for any purpose, including FDA audits.

The barcode feature reduces the amount of time that would otherwise be wasted manually verifying validation status of an entity. A tremendous amount of time is saved through the barcode feature and it allows entity specific validation information in real time on the production floor.

In the present invention, validation protocol can be executed electronically using an integrated system. The benefits of electronic execution include; a 100% paperless validation workflow, reduction in communication gaps that exist between executors and approvers of validation protocols, and the elimination of spelling mistakes and illegible data entries.

The system of the present invention is tightly integrated with word processors. The invention controls the word processor and allows only selected data entry positions to receive information or be modified by the user. The invention captures the user's identification information and enters the user identification information with a time stamp into each test case entry in the database.

Executing validation documents online through the present invention is compliant with FDA regulations since the user identification information with date and time stamps are captured for each test case database entry. The invention enforces accountability during the entire execution process from task assignment to document and deviation approvals.

The Food and Drug Administration (FDA) periodically issues a host of rulings and guidance to the regulated life sciences industry under which the agency allows the maintenance and submission of electronic records and the use of automated systems. The Federal Food, Drug, and Cosmetic Act, the Public Health Service Act, Part 11 of Title 21 of the Code of Federal Regulations (CFR); Electronic Records; Electronic Signatures (Part 11), and certain provisions of Current Good Manufacturing Practice (cGMP), the Quality System Regulation (QSR), and the Good Laboratory Practice (GLP) for Nonclinical Laboratory Studies each provide guidelines for the management of records relating to products regulated by such federal acts and regulations, and that are electronically created, modified, maintained, archived, retrieved, or transmitted.

In the present invention, the inventions database stores the required 21 CFR Part 11 and validation related information about each registered entity. 21 CFR Part 11 requirements are listed for the user, and, if the user selects the check box for the requirement to indicate that the system meets the specific requirement, the proposed system will receive and store the information to the invention's database. If the entity that is the subject of the user's interest contains no information or is missing information, the invention will alert the associated user of the incomplete information. After answering the full set of governmental regulations, a user can run a report which compares required regulations with the available features for each entity, and reports which regulations have not been met, or if information is missing.

It is appreciated that the relationships for the parts of the invention, to include variation in database and subsystem configuration to detach them for each other and provide the possibilities to deploy the system in different locations and under different authorities with division of labor, are deemed readily apparent and obvious to one of ordinary skill in the art, and all equivalent relationships to those illustrated in the drawings and described in the above description are intended to be encompassed by the present invention.

In addition, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A method for providing productivity in the validation process comprising:
a software system consisting of:
a user service layer;
a business logic service layer; and
a data service layer

2. The method for providing productivity in the validation process of claim 1 wherein the user service layer is further comprised of
a client presentation tier consisting of the client user interface and scripts, and an ActiveX component.

3. The method for providing productivity in the validation process of claim 2 wherein the Business Logic Service is further comprised of
a service business logic and ASP page Processing components, and system components.

4. The method for providing productivity in the validation process of claim 3 wherein the data service layer consists of
an SQL server business process logic,
a data source, and
a data source temp table used for document transactions.

5. The method for providing productivity in the validation process of claim 4 wherein
the client user interface and scripts create or edit documents via the ActiveX component or access the Business Logic Service; and
the ActiveX component accesses the client temp folder to retrieve information or engage the data source temp table to create, modify, and edit documents;
when the user gets the template, the document can be created and saved; and
the saved document can be accessed at any time to further develop the document.

6. The method for providing productivity in the validation process of claim 4 wherein the service business logic and ASP page Processing components interact directly with either the client user interface or the SQL server business process logic.

7. The method for providing productivity in the validation process of claim 5 wherein the SQL server business process logic obtains data from the data source or interacts with the data source temp table via FTP components to transfer the documents form client to server to create, modify, and edit documents.

8. The method for providing productivity in the validation process of claim 4 wherein
entities requiring validation include any software, hardware, equipment, or instrument, and can be categorized and further sub categorized for easy navigation in a tree hierarchy structure; and
registered entities are available for viewing and selection under appropriate sub categories in the tree hierarchy structure.

9. The method for providing productivity in the validation process of claim 4 further comprising an Inventory Report Manager providing means to
track the validation status of any entity that is registered in the system, and
store entities in the tree hierarchy structure for simplified navigation and selection.

10. The method for providing productivity in the validation process of claim 9 wherein the Inventory Report Manager provides automated means for readily locating an entity and providing complete details outlining the validation status with User ID and Date and Time Stamps captured for each activity associated with the entity.

11. The method for providing productivity in the validation process of claim 10 further comprising validation document templates which provide means for creating, registering, and storing any number of custom validation templates.

12. The method for providing productivity in the validation process of claim 11 wherein after a custom template is registered and stored in the database, the user responsible for creating a validation document for an entity must use the custom template, resulting in validation document consistency and compliance in the validation process.

13. The method for providing productivity in the validation process of claim 12 wherein
when a user creates a custom validation document template, the user inserts custom headers and footers to the validation document and pulls Meta data populating the custom validation document template dynamically from the database; and
the custom validation document template is registered into the system and is bound or linked to a specific validation type;
validation types are created separately;
templates are created separately; and
users can bind the custom validation document template for any validation type under category or sub category or entity.

14. The method for providing productivity in the validation process of claim 4 further comprising a revalidation scheduler that alerts predefined user groups of any scheduled or delayed revalidation tasks ensuring that critical entities are revalidated on time and in compliance with governmental regulations.

15. The method for providing productivity in the validation process of claim 14 wherein
all validated entities within the system may be selected or deselected by the user for inclusion in the revalidation schedule; and
once a revalidation schedule has been created, the selected user groups will be alerted of impending and delayed revalidation tasks through a Task Alert Feature as means for ensuring that users are notified of any impending document development, execution, or approval tasks.

16. The method for providing productivity in the validation process of claim 15 further comprising:
validation document number generation means for automatically generating unique, consistent validation document numbers, and
the generation of a unique barcode for each registered entity thereby providing means for a user to track the validation status of entities in remote locations.

17. The method for providing productivity in the validation process of claim 16 wherein
the barcode is printable using any printer and proper-sized labels that can be physically attached to the entity so it can be used to identify the validation details of the entity;
when scanned, the barcode label presents to the user the validation information stored in the invention's database associated with the barcode; and
the barcode code is configured to capture the validation status, revalidation schedule, and changes occurred after the validation.

18. The method for providing productivity in the validation process of claim 17 wherein, via a handheld scanning device, an entity can be scanned on a production floor with requested validation status details being displayed.

19. The method for providing productivity in the validation process of claim 4 wherein
validation protocol is executed electronically using an integrated software system;
the software system is integrated with word processors;
said software system controls the word processor providing means for only selected data entry positions to receive information or be modified by the user; and
said software system captures a user's identification information and enters the user's identification information with a time stamp into each case entry in the database.

20. The method for providing productivity in the validation process of claim 4 wherein
the database stores the required section of the code of federal regulation and validation related information about each registered entity;
code of federal regulation requirements are listed for the user, and when the user selects the check box for the requirement to indicate that the system meets the specific requirement, the software system will receive and store the information to the database;
if the entity contains no information or is missing information, the system will alert the user of the incomplete information; and
after answering the full set of governmental regulations, a user can run a report which compares required regulations with the available features for each entity, and reports which regulations have not been met, or if information is missing.

21. The method for providing productivity in the validation process of claim 20 wherein the required section of the code of federal regulation is 21 CFR Part 11.

22. The method for providing productivity in the validation process of claim 13 wherein
any template registered under a category, all the sub categories and entities underneath the category inherits the template;
any template registered under a sub category, all the entities under the sub category inherit the template; and
any template registered under an entity, the template is available only for said entity.

23. The method for providing productivity in the validation process of claim 13 wherein only bound templates are available for users to develop into the documents.

24. The method for providing productivity in the validation process of claim 13 wherein Dynamic Audit Trails for document development, execution, and approval tasks
are dynamically created;
capture User ID with Date and Time stamps for each activity that has occurred; and
are retrievable in real time.
